(19) United States
(12) Patent Application Publication
(10) Pub. No.: US 2004/0081394 A1
(43) Pub. Date: Apr. 29, 2004

(54) Providing control information to a management processor of a communications switch

(76) Inventors: Giora Biran, Zichron Ya'akov (IL); Dono Van-Mierop, Haifa (IL)

Correspondence Address: IBM Corporation, Intellectual Property Law Dept, P O Box 218, Yorktown Heights, NY, 10598, US

(21) Appl. No.: 10/470,366

(22) PCT Filed: Jan. 31, 2001
(86) PCT No.: PCT/IB01/00120

(51) Int. Cl. G02B 6/26; G02B 6/42

(52) U.S. Cl. 385/31

(57) ABSTRACT

A communication switch for a data communications network comprises: a buffer (340); a plurality of ports (300-307) for receiving a datagram from the network, the datagram containing control information; switching logic (320) for selectively interconnecting the ports (300-307); a management processor (330) for processing the control information to control the switching logic (320); a handshake flag accessible by the processor (330); and control logic (350) for storing the datagram in the buffer (340) at an address accessible by the processor (330) and for setting the handshake flag in response to the datagram being stored at the address. The processor (330) accesses the control information stored in the datagram in response to the handshake flag being set, processes the control information, and resets the handshake flag in response to the processing of the control information. The control logic (350) discards the datagram from the address in response to the handshake flag being reset.

The present invention generally relates to a communication switch for data communications network such as a system area network and a method for providing control information to a management processor of such a switch.

A conventional data processing system typically comprise a plurality of elements such as processing units and data storage devices all interconnected via a bus subsystem. A problem associated with conventional data processing systems is that the speed at which data can be processed is limited by the speed at which data can be communicated between the system elements via the bus subsystem. Attempts have been made to solve this problem by clustering elements of a data processing system together in via a local area network such as an Ethernet network to produce a System Area Network (SAN). However, conventional clustering technology is still relatively slow in comparison with available data processing speeds. Also, if the data processing system includes diverse hardware and software elements technologies, complex bridging is needed to implement the cluster.

InfiniBand (Service Mark of the InfiniBand Trade Association) is an emerging system area networking technique promulgated by the InfiniBand Trade Association for solving the aforementioned problems of conventional clustering technology. In an InfiniBand SAN, elements of a data processing system are interconnected by switched serial links. Each serial link operates at 2.5 Gbps point-to-point in a single direction. Bi-directional links can also be provided. Links can also be aggregated together to provide increased throughput. A typical SAN based on InfiniBand technology comprises a plurality of server or host computer nodes and a plurality of attached device. Each host comprises a host channel adapter (HCA). Each device 30-40 comprises a target channel adapter (TCA). The HCAs and TCAs are interconnected by a network of serial links. The interconnections are made via a switch fabric. The switch fabric may comprise a single switch or a plurality of switches. In operation, data is communicated between the hosts and devices over the network according to an internetworking protocol such an Internet Protocol Version 6 (IPv6).

Communications between nodes in the SAN is effected via messages. Examples of such messages include remote direct memory access (RDMA) read or write operations, channel send and receive messages, and multicast operations. An RDMA operation is a direct exchange of data between two nodes over the SAN. A channel operation provides connection-oriented set-up and control information. A multicast operation creates and controls multicast groups. Messages are sent within packets. Packets may be combined to make up a single message. Each end-node has a globally unique identifier (GID) for management purposes. Each HCA and TCA connected to an end-node has its own GID. The hosts may have several HCAs, each having its own GID, for redundancy or for connection to different switch fabrics. Furthermore, each TCA and HCA may have several ports each having its own local identifier (LID) which is unique to its own part of the SAN and switch. The GID is analogous to unique 128-bit IPv6 address, and the LID is a TCP or UDP port at that address.

Each connection between a HCA and a TCA is subdivided into a series of Virtual Lanes (VLs) to provide flow control for communications. The VLs permit separation of communications between the nodes of the network, thereby preventing interference between data transfers. One VL is reserved for management packets associated with the switch fabric. Differentiated services can be maintained for packet flow within each VL. For example, Quality of Service (QoS) can be defined between an HCA and TCA based on an interconnecting VL. The interconnected HCA and TCA can be defined as a Queue Pair (QP). Each end in the QP has a queue of messages to be delivered over the intervening link to the other end. Different service levels associated with different applications can be assigned to each QP. Operation of the SAN is controlled by a management infrastructure. The management infrastructure includes elements for handling management of the switch fabric. Messages are sent between elements of the management infrastructure across the SAN in the form of management datagrams. The management datagrams are employed for managing the SAN both during initialization of the SAN and during subsequent operation. The number of management datagrams traveling through the SAN varies depending on applications running in the SAN. However, management datagrams consume resources within the SAN that can otherwise be performing other operations. It would desirable to reduce demand placed on processing capability in the switch by management datagrams.

In accordance with the present invention there is now provided a method for providing control information to a management processor of a communications switch connected in a data communications network, the method comprising: receiving at the switch a datagram from the network, the datagram containing the control information; by control logic in the switch, storing the datagram in a buffer at an address accessible by the processor; by the control logic, setting a handshake flag in response to the datagram being stored at the address, the handshake flag being accessible by the processor; by the processor, accessing the control information stored in the datagram in response to the handshake flag being set and processing the control information; by the processor, resetting the handshake flag in response to the processing of the control information; by the control logic, discarding the datagram from the address in response to the handshake flag being reset.

The control logic preferably discards the datagram by replacing the datagram with a subsequently received datagram. Similarly, the control logic preferably discards the datagram on detecting an error therein. The processor is preferably provided, via the control logic, with randomly access to the control information in the datagram. The network preferably comprises an InfiniBand network.

Viewing the present invention from another aspect, there is now provided a communication switch for a data communications network, the switch comprising: a buffer; a plurality of ports for receiving a datagram from the network, the datagram containing control information; switching logic for selectively interconnecting the ports; a management processor for processing the control information to control the switching logic; a handshake flag accessible by the processor; and control logic for storing the datagram in the buffer at an address accessible by the processor and for setting the handshake flag in response to the datagram being stored at the address; wherein the processor accesses the control information stored in the datagram in response to the handshake flag being set, processes the control information, and resets the handshake flag in response to the processing of the control information, and the control logic discards the datagram from the address in response to the handshake flag being reset. The present invention also extends to a host computer system comprising a central processing unit, a switch as herein before described, and a bus subsystem interconnecting the central processing unit and the switch.

In a preferred embodiment of the present invention to be described shortly, there is provided a communications switch for a system area network, the switch comprising: a plurality of input/output (I/O) ports; switch logic coupled to the I/O ports; a management processor connected to the switch logic for controlling the switch logic to selectively interconnect the ports for effecting communication of data between selected ports; a management packet input buffer (MPIB) for storing management datagrams; and, buffer control logic connected to the MPIB, the management processor and the switch logic; wherein the buffer control logic permits only a subset of the addresses in the MPIB to be accessed by the management processor, the buffer control logic indicating to the management processor that a new management datagram is available by setting a handshake flag visible to the management processor in response to a complete management datagram being loaded into the MPIB, the management processor indicating that it has completed processing of the management datagram by clearing the handshake flag set by the buffer control logic, and, in response to clearance of the handshake flag by the management processor, the buffer control logic 350 replacing the management datagram in the MPIB with any new management datagram stored in the MPIB and indicating to the management processor that the new management packet is available in the MPIB by setting the handshake flag.

This arrangement advantageously permits the speed at which data is transferred through the ports to exceed the processing speed of the management processor without requiring an external buffer.

In a conventional solution, all management datagrams received at a switch are loaded into a random access memory. The management processor then handles all addressing of the management datagrams. This requires a more complex handshake between the control logic and management processor. The more complex handshake incurs increased processing burden on the management processor.

In a particularly preferred embodiment of the present invention, the buffer control logic tests incoming management datagrams for errors. Any erroneous management datagrams are not queued in the MPIB and are instead discarded by the buffer control logic. Erroneous datagrams are therefore disposed in a manner that is transparent to the management processor. In another conventional solution, all management datagrams received at a switch are kept in a first in, first out (FIFO) memory. This approach requires the management processor to copy all of each packet in internal memory in order to browse back and forth through control information contained in the management packet. This is not efficient for handling management datagrams in cases in which a very small portion of the datagram includes control information needed by the management processor.

In an especially preferred embodiment of the present invention, the buffer control logic provides the management processor with random access to any byte in the MPIB. The management processor can therefore browse back and forth through the management datagram stored in the subset of addresses in the MPIB without needing to read the entire management datagram.

Preferred embodiments of the present invention will now described, by way of example only, with reference to the accompanying drawings, in which:

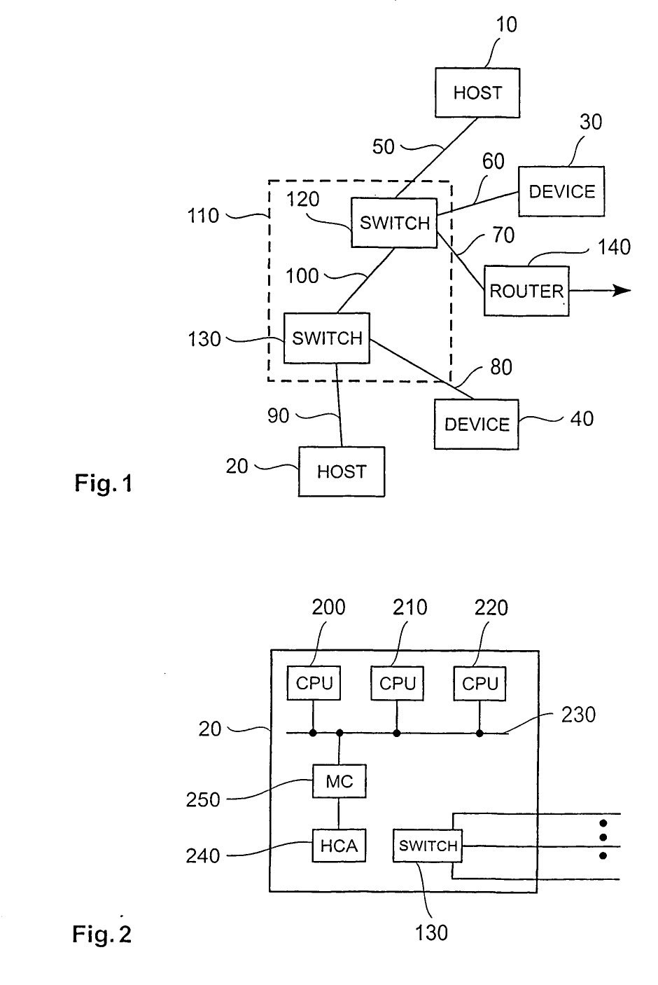

FIG. 1 is a block diagram of an system area network;

FIG. 2 is a block diagram of a host system for the system area network;

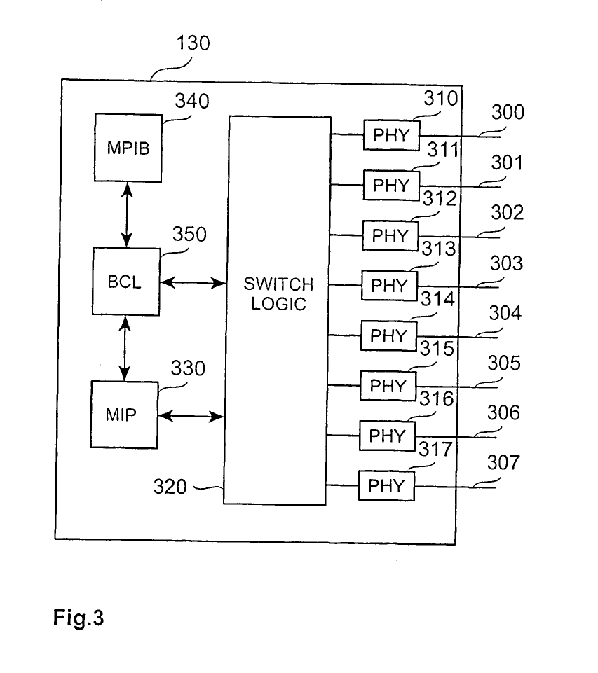

FIG. 3 is block diagram of a switch for the system area network;

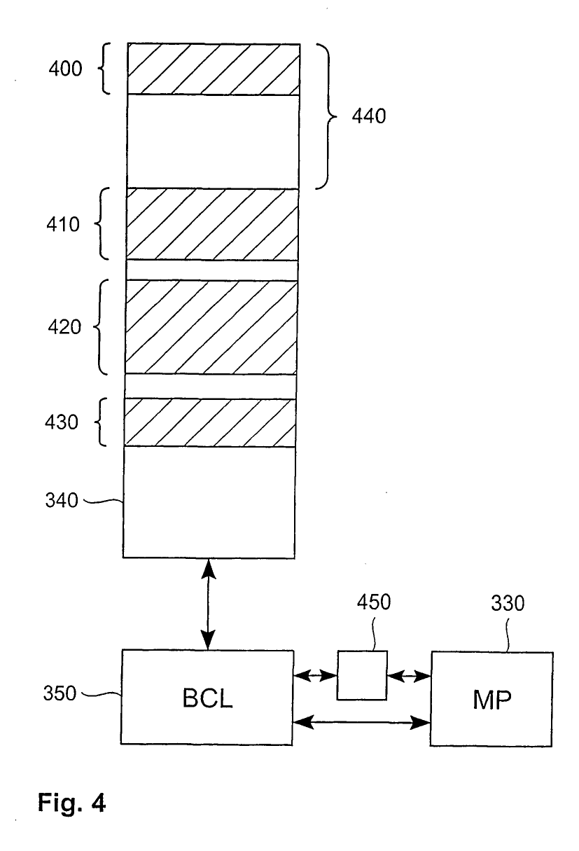

FIG. 4 is a block diagram of a management packet input buffer for the switch; and,

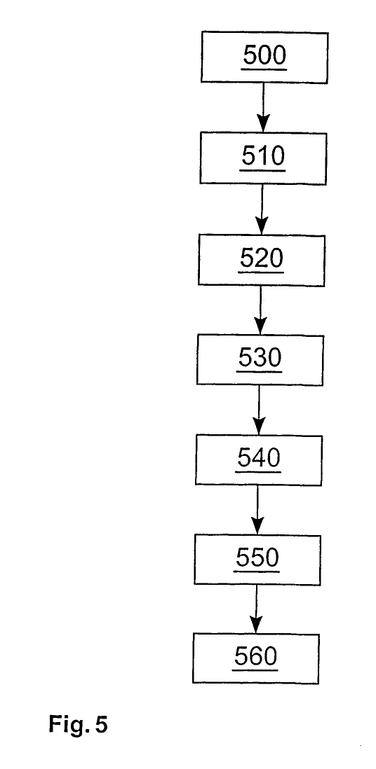

FIG. 5 is a flow chart associated with operation of control logic for the switch.

Referring first to FIG. 1, an example of a system area network (SAN) based on InfiniBand technology comprises a plurality server or host computer nodes 10-20 and a plurality of device 30-40. The attached devices 30-40 may be mass data storage devices, printers, client devices or the like. Each host 10-20 comprises a host channel adapter (HCA). Each device 30-40 comprises a target channel adapter (TCA). The HCAs and TCAs are interconnected by a network of serial links 50-100. The interconnections are made via a switch fabric 110 comprising a plurality switches 120-130. The SAN can also communicate with other networks via a router 140. In operation, data is communicated between the hosts 10-20 and devices 30-40 over the network according to an internetworking protocol such an Internet Protocol Version 6 (IPv6). IPv6 facilitates address assignment and routing and security protocols within the SAN. The HCAs and TCAs can communicate with each other according to either packet or connection based techniques. This permits convenient inclusion in the SAN of both devices that transfer blocks of data and devices that transfer continuous data streams.

Referring now to FIG. 2, the host computer node 20 comprises a plurality of central processing units (CPUs) 200-220 interconnected by a bus subsystem such as a PCI bus subsystem 230. A Host channel adapter (HCA) 240 is also coupled to the bus subsystem 230 via a memory controller 250. As shown in FIG. 2, the switch 130 may be integral to the host 20. The HCA 240 is interconnected to other nodes of the system area network via the switch 130. In operation, the CPUs 200-220 each execute computer program instruction code to process data stored in memory (not shown). Data communications between the CPUs 200-220 and other nodes of the SAN is effected via the bus sub system 230, the memory controller 250, the HCA 240 and the switch 130. The memory controller 250 permits communication of data between the bus-subsystem 230 and the HCA 240. The HCA 240 converts transient data between a format compatible with the bus subsystem 230 and a format compatible with the SAN and vice versa. The switch directs data arriving from the HCA 240 to its intended destination and directs data addressed to the HCA 240 to the HCA 240.

Communications between nodes 10-130 in the SAN is effected via messages. Examples of such messages include remote direct memory access (RDMA) read or write operations, channel send and receive messages, and multicast operations. An RDMA operation is a direct exchange of data between two nodes 10-40 over the network. A channel operation provides connection-oriented set-up and control information. A multicast operation creates and controls multicast groups. Messages are sent within packets. Packets may be combined to make up a single message. Messages are handled at operating system level within the nodes. However, packets are handled at network level. A reliable connection between end node 1040 of the SAN is established by a destination node 10-40 maintaining a sequence number for each packet, generating acknowledgment messages that are sent back to the source node 10-40 for each packet received, rejecting duplicate packets, notifying the source node 10-40 of missing packets for redelivery, and providing recovery facilities for failures in the switching fabric 110. Other types of connection between end nodes 10-40 may also be established based on different connection protocols in accordance with requirements of a specific communication task. Each end-node 10-40 has a globally unique identifier (GID) for management purposes. Each HCA and TCA connected to an end-node 10-40 has its own GID. The hosts 10-20 may have several HCAs, each having its own GID, for redundancy or for connection to different switch fabrics 110. Furthermore, each TCA and HCA may have several ports each having its own local identifier (LID) which is unique to its own part of the SAN and switch 120-130. The GID is analogous to unique 128-bit IPv6 address, and the LID is a TCP or UDP port at that address.

Each connection between a HCA and a TCA is subdivided into a series of Virtual Lanes (VLs) to provide flow control for communications. The VLs permit separation of communications between the nodes 10-130 of the network, thereby preventing interference between data transfers. One VL is reserved for management packets associated with the switch fabric 110. Differentiated services can be maintained for packet flow within each VL. For example, Quality of Service (QoS) can be defined between an HCA and TCA based on an interconnecting VL. The interconnected HCA and TCA can be defined as a Queue Pair (QP). Each end in the QP has a queue of messages to be delivered over the intervening link to the other end. Different service levels associated with different applications can be assigned to each QP. For example, a multimedia video stream may need a service level that offers a continuous flow of time-synchronized messages.

Operation of the SAN is controlled by a management infrastructure. The management infrastructure include elements for handling management of the switch fabric 110, partition management, connection management, device management, and baseboard management. The switch fabric management ensures that the switch fabric 110 is operating to provide a desired network configuration, and that the configuration can be changed to add or remove hardware. Partition management enforces quality of service (QoS) policies across the switch fabric 110. Connection management determines how channels are established between the end nodes 10-40. Device management handles diagnostics for, and controls identification, the end nodes 10-40. Baseboard management enables direct remote control of the hardware within the nodes 10-130. The Simple Network Management Protocol (SNMP) can be employed to provide an interface between the aforementioned management elements.

Messages are sent between elements of the management infrastructure across the SAN in the form of management datagrams. The management datagrams are transmitted through the aforementioned reserved VL in every link. Security keys are employed in by the management infrastructure to define the authorization needed to change the fabric or reprogram the nodes 10-130 of the SAN. Management datagrams are employed for managing the SAN both during initialization of the SAN and during subsequent operation. The number of management datagrams traveling through the SAN varies depending on applications running in the SAN. However, management datagrams consume resources within the SAN that can otherwise be performing other operations.

With reference to FIG. 3, the switch 130 comprises a plurality of input/output (I/O) ports 300-307 coupled to switch logic 320 via a corresponding plurality of physical layer interfaces 310-317. The physical layer interfaces 310-317 match (I/O) lines of the switch logic to physical network connections of the SAN. A management processor (MP) 330 configured by stored computer program instruction code is also connected to the switch logic 330. The switch logic 320 is controlled by the management processor 330 to selectively interconnect pairs of the ports 300-307 and thereby to effect communication of data between selected ports 300-307. The switch 130 also comprises a management packet input buffer (MPIB) 340. Buffer control logic 350 is connected to the MPIB 340, the management processor 330 and the switch logic 320.

Referring now to FIG. 4, in operation, management datagrams 400-430 received at the switch 130 are queued by the buffer control logic 350 in the MPIB 340 for supply to the management processor 330 via the buffer control logic 350. This permits the speed at which data is transferred through the ports 300-307 to exceed the processing speed of the management processor 330 without requiring an external buffer. The management packets are queued in the MPIB 340 in such a manner that only the packet in the head of the MPIB 340 is visible to the management processor 330. Specifically, the MPIB 340 comprises a plurality of addresses for storing management datagrams 400-430. However, the buffer control logic 350 permits only a subset 440 of the addresses in the MPIB 340 are accessible by the management processor 330. The subset 440 extends from the head of the MPIB 340. Datagram 400, for example, is located at the head of MPIB 340 and can therefore be accessed by the management processor 330. Datagram 410 however is located at an address in the MPIB which is outside the subset 440. Therefore, datagram 440 cannot be accessed by the management processor 330.

Once the complete management datagram 400 is loaded into the MPIB 340, the buffer control logic 350 indicates to the management processor 330 that the management datagram 400 is available by setting a handshake flag 450 visible to the management processor 330. The handshake flag 450 may, for example, be implemented by a register connected to the control logic 350 and the processor 330.

The buffer control logic 350 tests incoming management datagrams 400-430 for errors. Any erroneous management datagram are not queued in the MPIB 340 and are instead discarded by the buffer control logic 350. Erroneous datagrams are therefore disposed in a manner that is transparent to the management processor 330.

The buffer control logic 350 provides the management processor 330 with random access to any byte in the MPIB 340. The management processor 330 can therefore browse back and forth through the management datagram 400 stored in the subset 440 of addresses in the MPIB 340 without needing to read the entire management datagram 400.

The management processor 330 indicates that it has completed processing of the management datagram 400 by clearing the handshake flag 450 set by the buffer control logic 350. In response to clearance of the handshake flag 450, the buffer control logic 350 erases the management datagram 400 from the MPIB 340. The buffer control logic 350 then moves the next management datagram 410, if any, to the same address location in the MPIB 340. The buffer control logic 350 indicates to the management processor 330 that the new management packet 410 is available in the MPIB 340 by again setting the handshake flag 450. It will be appreciated that the buffer control logic 350 may be implemented by hardwired logic, a programmable logic array, a dedicated processor programmed by computer program code, or any combination thereof.

An example of a method for providing control information to the management processor 330 from the management datagrams 400-430 in a preferred embodiment of the present invention will now be described with reference to the flow chart shown in FIG. 5. Referring to FIG. 5, at step 500, the switch 130 receives a management datagram 320 from the SAN. At, step 510, the control logic 350 discarding the datagram 400 on detection of an error therein. At step 520, the control logic 350 stores the datagram in the MPIB 340 at an address accessible by the management processor 330. At step 530, the control logic 350 sets the handshake flag 450 in response to the datagram 400 being stored at the address. At step 540, the management processor 330 accesses the control information stored in the datagram 400 in response to the handshake flag 450 being set and processes the control information. At step 550, the management processor 330 resets the handshake flag having completed processing of the control information. At step 560, the control logic 350 discards the datagram 400 from the address in response to the handshake flag 450 being reset by the processor 330. In some embodiments of the present invention, the discarding of the datagram 400 at step 560 may include replacing the datagram 400 with a subsequently received datagram 410. Similarly, step 510 may omitted in some embodiments of the present invention. Also, in some embodiments of the present invention, step 540 may involve the processor 330 randomly accessing the control information in the datagram via the control logic 340.

1. A method for providing control information to a management processor of a communications switch connected in a data communications network, the method comprising:
receiving at the switch a datagram from the network, the datagram containing the control information;
by control logic in the switch, storing the datagram in a buffer at an address accessible by the processor;
by the control logic, setting a handshake flag in response to the datagram being stored at the address, the handshake flag being accessible by the processor;
by the processor, accessing the control information stored in the datagram in response to the handshake flag being set and processing the control information;
by the processor, resetting the handshake flag in response to the processing of the control information;
by the control logic, discarding the datagram from the address in response to the handshake flag being reset.

2. A method as claimed in claim 1, wherein the discarding of the datagram includes replacing the datagram with a subsequently received datagram

3. A method as claimed in claim 1 or claim 2, comprising, prior to the storing of the datagram, discarding the datagram on detection by the control logic of an error therein.

4. A method as claimed in any preceding claim, wherein the accessing of the datagram by the processor comprises randomly accessing the control information in the datagram via the control logic.

5. A method as claimed in any preceding claim, wherein the network comprises an InfiniBand network.

6. A communication switch for a data communications network, the switch comprising: a buffer; a plurality of ports for receiving a datagram from the network, the datagram containing control information; switching logic for selectively interconnecting the ports; a management processor for processing the control information to control the switching logic; a handshake flag accessible by the processor; and control logic for storing the datagram in the buffer at an address accessible by the processor and for setting the handshake flag in response to the datagram being stored at the address; wherein the processor accesses the control information stored in the datagram in response to the handshake flag being set, processes the control information, and resets the handshake flag in response to the processing of the control information, and the control logic discards the datagram from the address in response to the handshake flag being reset.

7. A switch as claimed in claim 6, wherein the control logic discards the datagram by replacing the datagram with a subsequently received datagram

8. A switch as claimed in claim 6 or claim 7, wherein, prior to storing the datagram in the buffer, the control logic discards the datagram on detection of an error therein.

9. A switch as claimed in any preceding claim, wherein the control logic provides the processor with random access to the control information in the datagram.

10. A switch as claimed in any preceding claim for an InfiniBand network.

11. A host computer system comprising a central processing unit, a switch as claimed in any preceding claim, and a bus subsystem interconnecting the central processing unit and the switch.
